(19) United States
(12) Patent Application Publication
(10) Pub. No.: US 2022/0383311 A1
(43) Pub. Date: Dec. 1, 2022

(54) ELECTRONIC SYSTEM FOR REMOTE CONSENSUS AUTHORIZATION FOR RESOURCE USAGE

(71) Applicant: BANK OF AMERICA CORPORATION, Charlotte, NC (US)

(72) Inventor: Joseph Benjamin Castinado, North Glenn, CO (US)

(73) Assignee: BANK OF AMERICA CORPORATION, Charlotte, NC (US)

(21) Appl. No.: 17/329,594

(22) Filed: May 25, 2021

(51) Int. Cl. G06Q 20/40; G06N 20/00; G06N 5/04; G06Q 20/02

(52) U.S. Cl. CPC G06Q 20/401; G06N 20/00; G06N 5/04; G06Q 20/02

(57) ABSTRACT

Embodiments of the invention relate to systems, methods, and computer program products for remote consensus authorization, the invention including: receiving, from a managing entity system, information associated with a pending resource transfer; predicting, via a machine learning engine, that the pending resource transfer, in combination with a set of decision factors, will meet a set of requirements for a consensus trigger; transmitting, to one or more group members, a request for authorization of the pending resource transfer; receiving, from each of the group members, a response, where each response includes either an authorization or a denial of the pending resource transfer; determining, based on the responses, that an amount of responses including an authorization meets a predetermined threshold amount of authorization responses; and transmitting, to the managing entity system, instructions to authorize the pending resource transfer.

### BACKGROUND

Many consumers, especially consumers who have recently become financially independent or are otherwise experiencing changes to their financial circumstances, seek out advice and/or feedback from trusted individuals when making purchases or other decisions. In other cases, consumers are often tasked with making purchases on behalf of a group, sometimes using a shared or organizational resource instrument. One of the issues associated with such scenarios, however, is the lack of visibility or oversight provided to said trusted individuals or group members. As such, a need exists for a system which is able to provide flexible, proactive group management of resource transactions.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the invention relate to systems, methods, and computer program products for remote consensus authorization, the invention including: receiving, from a managing entity system, information associated with a pending resource transfer, where the information includes information identifying a user associated with the pending resource transfer; predicting, via a machine learning engine, that the pending resource transfer, in combination with a set of decision factors, will meet a set of requirements for a consensus trigger; transmitting, to one or more user devices, where each of the user devices is associated with a group member, a request for authorization of the pending resource transfer; receiving, from each of the plurality of user devices, a response, where each response includes either an authorization or a denial of the pending resource transfer; determining, based on the responses, that an amount of responses including an authorization meets a predetermined threshold amount of authorization responses; and transmitting, to the managing entity system, instructions to authorize the pending resource transfer.

In some embodiments, the invention further includes receiving, from a user device associated with the user, information identifying at least one group member and a level of permission for each of the at least one group members.

In some embodiments, information associated with a pending resource transfer further includes at least one of: a transfer amount, information identifying a user account or resource instrument associated with the pending resource transfer, a present balance associated with the user account or resource instrument, a merchant or third party system associated with the pending resource transfer, or a spending category.

In some embodiments, the set of decision factors includes at least one of: historical user data, past account activity, frequency of past resource transfers, amounts of past resource transfer, spending categories of past resource transfers, or results of past remote consensus requests.

In some embodiments, each response further includes one or more conditions for authorization and the invention further includes, when determining, based on the responses, that an amount of responses including an authorization meets a predetermined threshold amount of authorization responses, determining a majority of the responses information one or more matching conditions for authorization.

In some embodiments, the instructions to authorize the pending resource transfer further include instructions to only authorize the pending resource transfer when the one or more matching conditions are met.

In some embodiments, the invention further includes predicting, via the machine learning engine, that the pending resource transfer, in combination with the set of decision factors, will meet a set of requirements for an automatic transfer authorization or an automatic transfer denial.

In some embodiments, the set of requirements for a consensus trigger and the set of requirements for automatic transfer authorization or automatic transfer denial are determined based on input received from a user device associated with the user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates an operating environment for the remote consensus system, in accordance with one embodiment of the present disclosure;

FIG. 2 is a block diagram illustrating the remote consensus system, in accordance with one embodiment of the present disclosure;

FIG. 3 is a block diagram illustrating a user device associated with the remote consensus, in accordance with one embodiment of the present disclosure;

FIG. 4 is a flow diagram illustrating a process using the remote consensus system, in accordance with one embodiment of the present disclosure; and

FIG. 5 is a flow diagram illustrating another process using the remote consensus system, in accordance with one embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“Entity” or “managing entity” as used herein may refer to any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, or the like. The account is associated with and/or maintained by the entity. In other embodiments, an entity may not be a financial institution. In still other embodiments, the entity may be the merchant itself

“Entity system” or “managing entity system” as used herein may refer to the computing systems, devices, software, applications, communications hardware, and/or other resources used by the entity to perform the functions as described herein. Accordingly, the entity system may comprise desktop computers, laptop computers, servers, Internet-of-Things (“IoT”) devices, networked terminals, mobile smartphones, smart devices (e.g., smart watches), network connections, and/or other types of computing systems or devices and/or peripherals along with their associated applications.

“User” as used herein may refer to an individual associated with an entity. As such, in some embodiments, the user may be an individual having past relationships, current relationships or potential future relationships with an entity. In some embodiments, a user may be an employee (e.g., an associate, a manager, an administrator, or the like) of the entity or enterprises affiliated with the entity, capable of operating the systems described herein. In some instances, a “user” is an individual who has a relationship with the entity, such as a customer or a prospective customer. In other embodiments, a user may be a system performing one or more tasks described herein. “Group” as used herein may refer to any plurality of users as defined herein that have collective oversight into one or more accounts or resource instruments associated with said accounts. In some instances, a “group” is a plurality of individuals selected by a user to be granted access to the features and functions of the system claimed herein. In some instances, a “group” consists of members of an organization or entity of which a user is also associated. A “group member” may be any one individual associated with a group. Members of a group may all have equal access and insight into an account and/or resource instrument or may be granted varying levels of permission according to a user associated with said account or resource instrument.

Accordingly, as used herein the term “user device” or “mobile device” may refer to mobile phones, personal computing devices, tablet computers, wearable devices, and/or any portable electronic device capable of receiving and/or storing data therein.

“Transaction” or “resource transfer” as used herein may refer to any communication between a user and a third party merchant or individual to transfer funds for purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

The system described herein allows for flexible, proactive group management of resource transfers by utilizing machine learning techniques to trigger group consensus requests for resource transfers meeting certain criteria. For example, a group may utilize the features and functions of the system to set a budget for a particular account or resource instrument, requiring a group consensus to be met before authorizing transfers outside of said budget. In another example, a group of guardians of a dependent user may utilize the features and functions of the system to proactively manage an account by limiting transfers to a particular frequency, amount, or spending category. The system may benefit both group members by providing oversight and management into a particular account or resource instrument. The system may also benefit a user who may also be a group member, by providing convenient, flexible, and real-time approval of resource transfers.

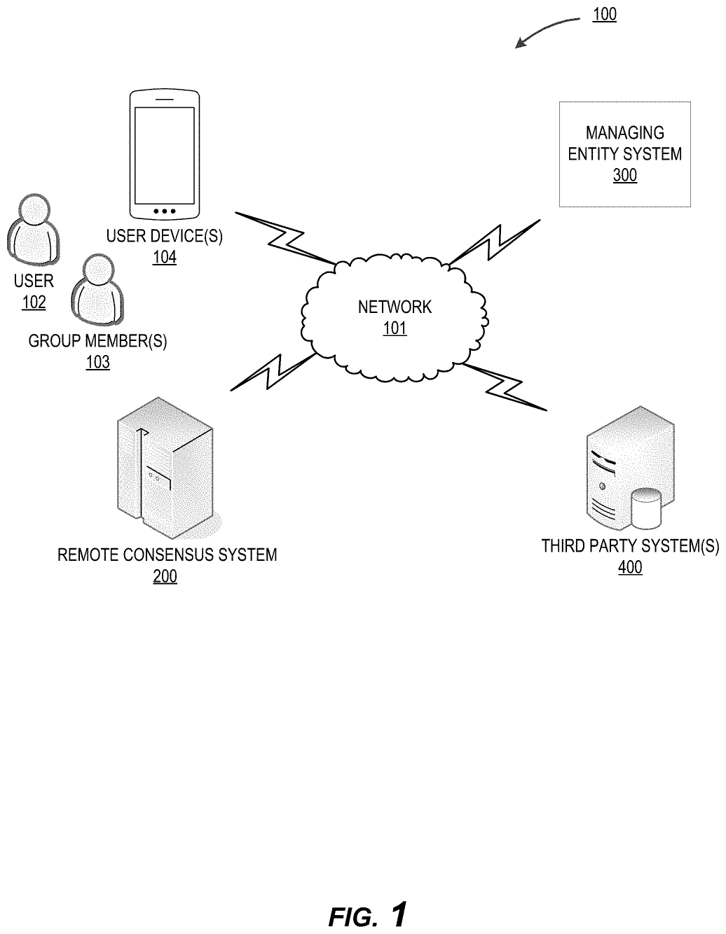

FIG. 1 illustrates an operating environment 100 for the remote consensus system, in accordance with one embodiment of the present disclosure. As illustrated, the operating environment 100 may comprise a user 102, a plurality of group members 103, and/or one or more user devices 104 in operative communication with one or more third party systems 400 (e.g., third party merchant systems). The operative communication may occur via a network 101 as depicted, or in some embodiments the user 102 may be physically present at a location associated with the third party, such as a computer terminal or point-of-sale device located within a storefront. The operating environment also includes a managing entity system 300, a remote consensus system 200, and/or other systems/devices not illustrated herein and connected via a network 101. As such, the user 102 may receive a transaction authorization from the group members 103 by establishing operative communication channels between a plurality of user devices 104, the managing entity system 300, and the third party system 400 via a wireless network 101. In some embodiments, the user 102 may complete a resource transfer with a third party by interfacing directly with the third party system 400, which may then establish operative communication with the managing entity system 300 and remote consensus system 200 via a wireless network in order to execute the resource transfer.

Typically, the remote consensus system 200 and the one or more third party systems 400 are in operative communication with the managing entity system 300 via the network 101, which may be the internet, an intranet or the like. In FIG. 1, the network 101 may include a local area network (LAN), a wide area network (WAN), a global area network (GAN), and/or near field communication (NFC) network. The network 101 may provide for wireline, wireless, or a combination of wireline and wireless communication between devices in the network. In some embodiments, the network 101 includes the Internet. In some embodiments, the network 101 may include a wireless telephone network. Furthermore, the network 101 may comprise wireless communication networks to establish wireless communication channels such as a contactless communication channel and a near field communication (NFC) channel (for example, in the instances where communication channels are established between one or more of the user devices 104 and the third party system 400). In this regard, the wireless communication channel may further comprise near field communication (NFC), communication via radio waves, communication through the internet, communication via electromagnetic waves and the like.

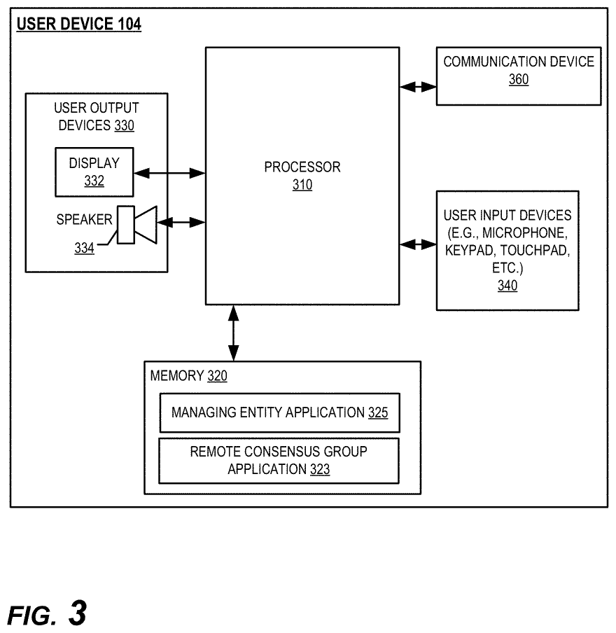

The user device(s) 104 may comprise a mobile communication device, such as a cellular telecommunications device (i.e., a smart phone or mobile phone), a computing device such as a laptop computer, a personal digital assistant (PDA), a mobile internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like. The user device(s) are described in greater detail with respect to FIG. 3.

The managing entity system 300 may comprise a communication module and memory not illustrated and may be configured to establish operative communication channels with the remote consensus system 200 and/or the one or more third party systems 400 via a network 101. The managing entity system 300 may comprise a user data repository which stores user account data. This data may be used by the managing entity to facilitate resource transfers between the user 102, user devices 104, and/or the third party system 400. In some embodiments, the managing entity system is in operative communication with the remote consensus system 200 via a private communication channel. The private communication channel may be via a network 101 or the remote consensus system 200 may be fully integrated within the managing entity system 300.

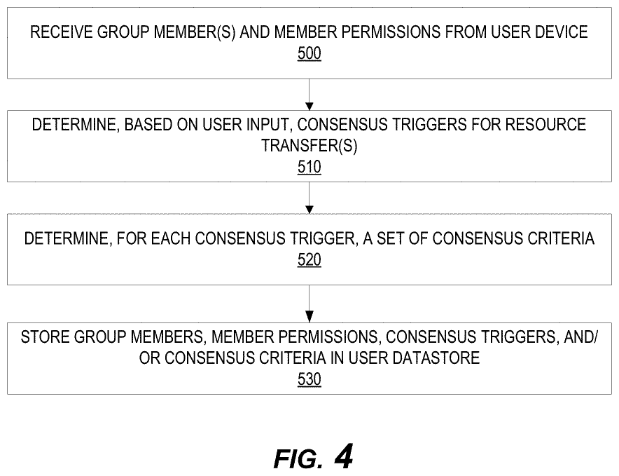

As will be discussed in greater detail in FIG. 4, the managing entity system 300 may communicate with the remote consensus system 200 in order to transmit data associated with electronic resource transfers initiated by a user 102, as well as to receive transfer authorization obtained from the group member(s) 103 by the remote consensus system 200. In some embodiments, the managing entity may utilize the features and functions of the remote consensus system 200 to authorize or deny resource transfers initiated by the user 102. The managing entity may also utilize the features and functions of the remote consensus system 200 to receive instructions relating to one or more remedial actions to be taken with respect to a user account after execution of a resource transfer.

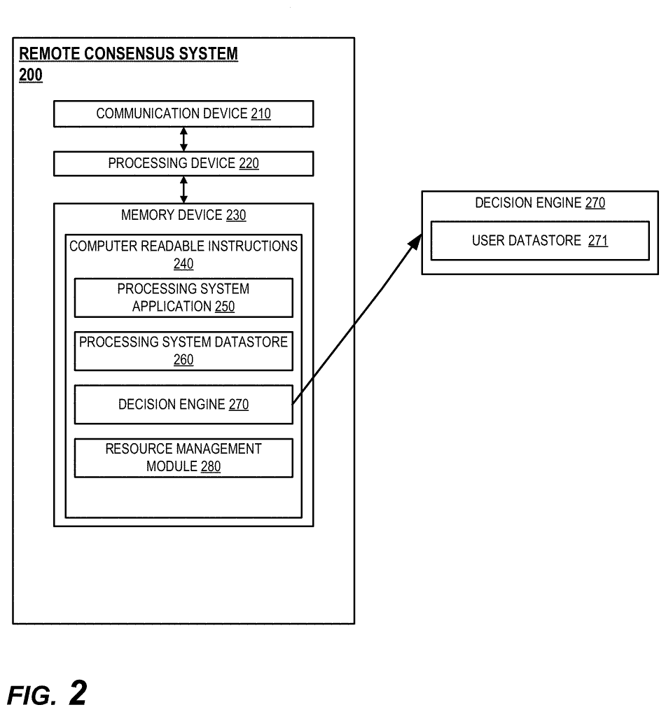

FIG. 2 illustrates a block diagram of the remote consensus system 200 associated with the operating environment 100, in accordance with embodiments of the present invention. As illustrated in FIG. 2, the remote consensus system 200 may include a communication device 210, a processing device 220, and a memory device 230 having a decision engine 270, a resource management module 280, a processing system application 250 and a processing system datastore 260 stored therein. As shown, the processing device 220 is operatively connected to and is configured to control and cause the communication device 210 and the memory device 230 to perform one or more functions. In some embodiments, the resource management module 280, the decision engine 270 and/or the processing system application 250 comprise computer readable instructions 240 that when executed by the processing device 220 cause the processing device 220 to perform one or more functions and/or transmit control instructions to the managing entity system 300, the third party system(s) 400, the user device(s) 104, and/or the communication device 210. It will be understood that the resource management module 280, the decision engine 270 and/or the processing system application 250 may be executable to initiate, perform, complete, and/or facilitate one or more portions of any embodiments described and/or contemplated herein. The resource management module 280 may comprise executable instructions associated with decisioning and logic related to user account actions and may be embodied within the processing system application 250 in some instances. The remote consensus system 200 may be owned by, operated by and/or affiliated with the same managing entity that owns or operates the managing entity system 300. In some embodiments, the remote consensus system 200 is fully integrated within the managing entity system 300.

The decision engine 270 may further comprise a user datastore 271. The user datastore 271 may store instructions and/or data that may cause or enable the remote consensus system 200 to receive, store, and/or analyze data received by the managing entity system 300, the user device(s) 104, and/or the third party system 400. The user datastore may receive and store data and/or metadata to determine and/or update consensus triggers as is discussed in greater detail with regards to FIG. 4. The decision engine 270 may also store instructions and/or data that cause or enable the remote consensus system 200 to determine, in real-time and based on received information, a level of authorization required to authorize a pending resource transfer.

The decision engine 270 may receive data from a plurality of sources and apply one or more machine learning algorithms to said data. Various machine learning algorithms may be used without departing from the invention, such as supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and the like. Additional or alternative machine learning algorithms may be used without departing from the invention.

The decision engine 270 may utilize the user datastore 271 and said machine learning algorithms to link two or more decision factors (e.g. historical user data, past account activity, past resource transfer details (e.g. frequency, amount, spending categories, or the like), pending resource transfer details (e.g. amount, user account and resource instrument to be used, present account and resource instruments balances, associated merchant or third party system, or the like), a spending category, the results of past remote consensus requests, and/or the like) to identify one or more patterns or transfer sequences that may directly and/or indirectly aid in predicting whether a pending resource transfer will match a consensus trigger, initiating an authorization request to be sent to one or more group members as is discussed in greater detail with regards to FIG. 4. In some embodiments, the decision engine 270 may apply machine learning algorithms in an iterative manner, in order to predict future conditions which may predict a consensus trigger. For example, the decision engine 270 may predict, based on a spending category of a resource transfer, an associated resource instrument. The results of said prediction may be used in turn to predict whether the resource transfer will result in activation of a consensus trigger.

The communication device 210 may generally include a modem, server, transceiver, and/or other devices for communicating with other devices on the network 101. The communication device 210 may be a communication interface having one or more communication devices configured to communicate with one or more other devices on the network 101, such as the managing entity system 300, the user device(s) 104, the third party system(s) 400, and/or other processing systems, data systems, and the like

Additionally, referring to the remote consensus system 200 illustrated in FIG. 2, the processing device 220 may generally refer to a device or combination of devices having circuitry used for implementing the communication and/or logic functions of the data obfuscation system 200. For example, the processing device 220 may include a control unit, a digital signal processor device, a microprocessor device, and various analog-to-digital converters, digital-to-analog converters, and other support circuits and/or combinations of the foregoing. Control and signal processing functions of the data obfuscation system 200 may be allocated between these processing devices according to their respective capabilities. The processing device 220 may further include functionality to operate one or more software programs based on computer-executable program code 240 thereof, which may be stored in a memory device 230, such as the processing system application 250 and the identification engine 270. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device 220 may be configured to use the network communication interface of the communication device 210 to transmit and/or receive data and/or commands to and/or from the other devices/systems connected to the network 101.

The memory device 250 within the remote consensus system 200 may generally refer to a device or combination of devices that store one or more forms of computer-readable media for storing data and/or computer-executable program code/instructions. For example, the memory device 250 may include any computer memory that provides an actual or virtual space to temporarily or permanently store data and/or commands provided to the processing device 242 when it carries out its functions described herein.

FIG. 3 illustrates a block diagram of one of the one or more user devices associated with the remote consensus system, in accordance with embodiments of the present invention. The user device 104 may include a user mobile device or the like. A “mobile device” 104 may be any mobile communication device, such as a cellular telecommunications device (i.e., a cell phone or mobile phone), personal digital assistant (PDA), a mobile Internet accessing device, or another mobile device including, but not limited to portable digital assistants (PDAs), pagers, mobile televisions, gaming devices, laptop computers, cameras, video recorders, audio/video player, radio, GPS devices, any combination of the aforementioned devices.

The user device 104 may generally include a processing device or processor 310 communicably coupled to devices such as, a memory device 350, user output devices 340 (for example, a user display or a speaker), user input devices 330 (such as a microphone, keypad, touchpad, touch screen, and the like), a communication device or network interface device 360, a positioning system device 320, such as a geo-positioning system device like a GPS device, an accelerometer, and the like, one or more chips, and the like.

The processor 310 may include functionality to operate one or more software programs or applications, which may be stored in the memory device 320. For example, the processor 310 may be capable of operating applications such as a remote group consensus application 323, a managing entity application 325, or a web browser application. The remote group consensus application 323 may allow the user device 104 to transmit and receive data and instructions to or from the remote consensus system 200, third party system 300 and/or another user device 104. The managing entity application 325 may allow the user device 104 to transmit and receive data to or from the managing entity system 300 (for example, via wireless communication or NFC channels), data and instructions to or from the remote consensus system 200, web content, such as, for example, location-based content and/or other web page content, according to a Wireless Application Protocol (WAP), Hypertext Transfer Protocol (HTTP), and/or the like. The remote consensus group application 323 may be fully integrated within the managing entity application 325 and may allow a user 102 and/or group member(s) 103 to view pending resource transfers, approve or deny said transactions, and data and/or other information relating to the features and functions of the remote consensus system 200.

The processor 310 may be configured to use the communication device 360 to communicate with one or more devices on a network 101 such as, but not limited to the third party system 400, the managing entity system 300, and other user devices 104. In this regard the processor 310 may be configured to provide signals to and receive signals from the communication device 360. The signals may include signaling information in accordance with the air interface standard of the applicable BLE standard, cellular system of the wireless telephone network and the like, that may be part of the network 101. In this regard, the user device 104 may be configured to operate with one or more air interface standards, communication protocols, modulation types, and access types. By way of illustration, the user device 104 may be configured to operate in accordance with any of a number of first, second, third, and/or fourth-generation communication protocols and/or the like. For example, the mobile device 104 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The user device 104 may also be configured to operate in accordance with non-cellular communication mechanisms, such as via a wireless local area network (WLAN) or other communication/data networks. The user device 104 may also be configured to operate in accordance Bluetooth® low energy, audio frequency, ultrasound frequency, or other communication/data networks.

The communication device 360 may also include a user activity interface presented in user output devices 330 in order to allow a user 102 or group member(s) 103 to execute some or all of the processes described herein. The application interface may have the ability to connect to and communicate with an external data storage on a separate system within the network 101. The user output devices 330 may include a display 332 (e.g., a liquid crystal display (LCD) or the like) and a speaker 334 or other audio device, which are operatively coupled to the processor 310. The user input devices 340, which may allow the user device 104 to receive data from the user 102 or group member(s) 103, may include any of a number of devices allowing the user device 104 to receive data, such as a keypad, keyboard, touch-screen, touchpad, microphone, mouse, joystick, other pointer device, button, soft key, and/or other input device(s).

The user device 104 may also include a memory buffer, cache memory or temporary memory device 320 operatively coupled to the processor 310. As used herein, memory may include any computer readable medium configured to store data, code, or other information. The memory device 320 may include volatile memory, such as volatile Random Access Memory (RAM) including a cache area for the temporary storage of data. The memory device 320 may also include non-volatile memory, which can be embedded and/or may be removable. The non-volatile memory may additionally or alternatively include an electrically erasable programmable read-only memory (EEPROM), flash memory or the like.

In some instances, various features and functions of the invention are described herein with respect to a “system.” In some instances, the system may refer to the remote consensus system 200 performing one or more steps described herein in conjunction with other devices and systems, either automatically based on executing computer readable instructions of the memory device 230, or in response to receiving control instructions from the managing entity system 300. In some instances, the system refers to the devices and systems on the operating environment 100 of FIG. 1. The features and functions of various embodiments of the invention are be described below in further detail. It is understood that the servers, systems, and devices described herein illustrate one embodiment of the invention. It is further understood that one or more of the servers, systems, and devices can be combined in other embodiments and still function in the same or similar way as the embodiments described herein.

FIG. 4 is a high-level process flow diagram illustrating a process using the remote consensus system, in accordance with one embodiment of the present disclosure. The process beings at block 500, where the remote consensus system 200 receives, from a user device 104 associated with a user 102, a data transmission identifying a set of at least one group member(s) 103. Each group member 103 may also be associated with a user device 104 with a remote consensus application 323 stored thereon. The data identifying the set of group members may be any unique information such as name or username, email address, phone number, or the like. In some embodiments, each group member also transmits, via a user device, a request to become a group member for the user 102 to the remote consensus. Additionally or alternatively, the remote consensus system 200 may, after receiving the identification information, transmit a notification to each of the user devices 104 associated with the group members 103. The notification may comprise an invitation to join a group associated with the user 102, and the group members 103 may then choose to accept or deny the invitation.

In some embodiments, the data transmission from the user 102 may also identify a set of permissions for each group member 103. The permissions may be the same for each group member 103 or may be unique to each group member 103. The permissions may include a level of account visibility, wherein the user 102 selects information associated with one or more user accounts which a group member may be able to view via the remote consensus application 323. Information associated with an account may include a transaction history, balance and/or payment history, account name and/or number, information identifying a resource instrument associated with the account, or the like. Additionally or alternatively, each set of permissions may include a level of consensus authority, wherein a level of authority may be associated with a number of votes available to a group member (such as one vote, one and a half votes, two votes, or the like), an ability to specify particular conditions for approval or denial, an ability to act as a tiebreaker vote, and/or the like. In some embodiments, each group member may also transmit, via an associated user device, a requested set of permissions to the remote consensus system 200. The remote consensus system 200 may then transmit a notification to the user device associated with the user 102. The notification may comprise the requested set of permissions from each group member 103 and the user 102 may then choose to accept, deny, and/or modify the set of permissions.

The process may then continue to block 510, where the remote consensus system 200 may, based on input from the user 102, determine a set of consensus triggers, where each consensus trigger is based on a combination of decision factors. The user input may include information relating to types of resource transfers which the user and/or group members will require a group consensus to approve or deny. For example, in a scenario where each of the group members are members of an organization, a group consensus may be required when a resource transfer may exceed a predetermined budget. In another example, where each of the group members are parents or guardians of a dependent user, a group consensus may be required when a resource transfer is in a particular spending category or if a combined history of resource transfers has exceeded a predetermined threshold amount. The user input may further comprise an indication of when a pending resource transfer should be automatically authorized or automatically denied by the remote consensus system without requiring a remote consensus. As discussed in greater detail with respect to FIG. 2, the decision factors used to establish a consensus trigger may include information received from the user 102 or a group member 103 via a user device 104, information received from the managing entity system 300 or a third party system 400, and/or information stored in the memory of the remote consensus system 200.

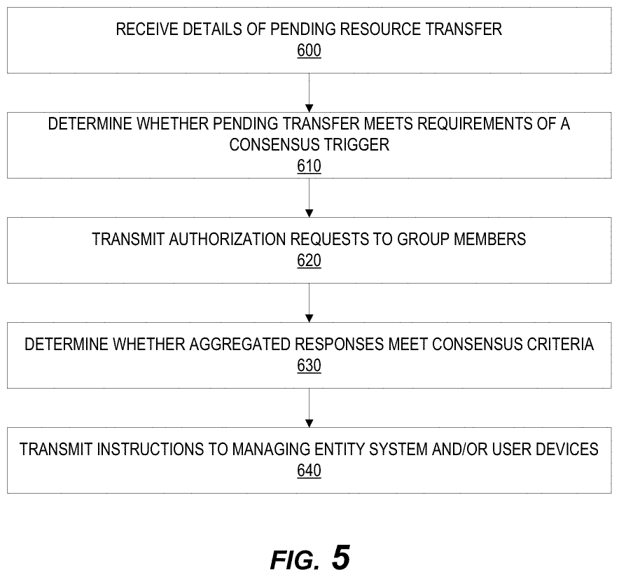

The process may continue to block 520, wherein for each determined consensus trigger, the remote consensus system may determine a set of consensus criteria required to authorize a pending resource transfer. Consensus criteria may be determined via a user input from the user 102, and/or the remote consensus system 200 may present the user 102 with a plurality of potential sets of consensus criteria to choose from. In some embodiments, consensus criteria may include a number or percentage of group members 103 which must approve a transfer in order for it to be authorized, such as 50%, 75%, 90%, or the like. Additionally or alternatively, consensus criteria may include more specific requirements for authorization, such as requiring an approval from one or more group members with a particular level of consensus authority, as well as a majority of approvals from the other group members 103. As is discussed in greater detail with respect to FIG. 5, an approval from a group member 103 may include one or more limitations or conditions for approval. In such embodiments, consensus criteria may also include requirements for how the system 200 will handle the limitations or conditions for approval. For example, the consensus criteria may require that the system authorizes a pending resource transfer only when a condition specified by a majority of the group members is met. In another example, the consensus criteria may require that the system authorizes a pending resource transfer only when each condition specified by each group member is met, and/or when each condition specified by two or more group members is met. In some embodiments, the conditions specified by the group members may comprise an approved level or acceptable threshold of variation between the authorized transfer and an actual future transfer. For example, a group member may authorize the amount of a pending transfer, as well as authorize any change in transfer amount up to 10% more or the like. In another example, a group member may authorize the resource instrument associated with a pending transfer, as well as authorize the use of one or more alternate resource instruments. The process may then be complete in block 530, wherein the system 200 stores the group members, group member permissions, consensus triggers, and/or consensus criteria in the user datastore 271 of the decision engine 270.

FIG. 5. is a high-level process flow diagram illustrating another process using the remote consensus system, in accordance with one embodiment of the present disclosure. The process begins at block 600, wherein the remote consensus system 200 receives details of a pending or future resource transfer associated with a user 102. In some embodiments, the system receives details from the managing entity system 300 after the resource transfer has been initiated by the user 102. Additionally or alternatively, the system may receive details from a user device 104 associated with the user 102, after the user inputs information relating to a potential future resource transfer using the remote consensus application 323. For example, a user 102 may utilize the remote consensus system 200 to identify whether a transfer would be approved before initiating said transfer with a merchant or third-party system 400.

The process may then continue to block 610, wherein the remote consensus system 200, via the decision engine 270, uses various machine learning techniques to predict whether the pending resource transfer in combination with other decision factors will meet the requirements of a consensus trigger. The decision engine 270 may also predict whether the pending resource transfer will meet the requirements of an automatic authorization or denial by the remote consensus system 200. As is discussed in greater detail with respect to FIG. 4, the requirements for a consensus trigger may be based on patterns or trends identified by the combination of decision factors and the details of the pending transfer, such as frequency of transfers, average transfer amounts, average balance of a resource instrument associated with the pending transfer, and or the like. For example, in some embodiments, a consensus trigger may be activated if a particular resource instrument has been used more than a certain number of times in a given period of time (e.g. five uses in one week, three uses in one day, etc.). The decision engine 270 may then, based on the details of a pending transfer, predict a resource instrument which will be utilized. The decision engine 270 may then identify whether the usage of said resource instrument will result in activation of a consensus trigger. If the pending resource transfer in combination with the other decision factors meets the requirements of an automatic authorization or denial of the transfer, the remote consensus system may transmit a notification of the authorization or denial to the managing entity system 300 and/or the user device 104 associated with the user 102.

In some embodiments, the process may then continue to block 620, wherein if a consensus trigger has been activated, the remote consensus system 200 transmits an authorization request to the remote consensus application(s) 323 of a set of user devices associated with the specific set of group members 103 defined by the specific consensus trigger. The authorization request may comprise details of the pending resource transfers, as well as one or more potential transfer variations. For example, the authorization request may specify an asset to be purchased, as well as a range of potential amounts that the asset may be purchased for. In some embodiments, each authorization request allows a group member 103 to approve or deny the pending resource transfer. Additionally or alternatively, each authorization request may include a plurality of limitations or conditions to an approval or denial such as an approved time to execute the transaction, an approved amount other than the original amount of the pending transfer, a requirement that a particular resource instrument be used, or the like. For example, a group member 103 may be able to approve a transfer with the limitation that the user 102 may not initiate another transfer with the same third-party system for 30 days. In another example, a group member 103 may be able to deny a transfer until a balance on the resource instrument being used is reduced, at which point the transfer may be approved.

The process may then continue to block 630, wherein the remote consensus system 200 may receive a response to each authorization request and determine, via the resource management module 280, an action to be executed. In some embodiments, the system may wait until each of the authorization requests has received a response before proceeding. Additionally or alternatively, the system may wait for a predetermined threshold number of responses to be received, such as 50%, 75%, 90% or the like. Based on the consensus trigger, the system may then determine whether the received responses meet the predetermined consensus criteria in order to proceed with the pending resource transfer, as is discussed in greater detail with respect to FIG. 4. In some embodiments, the system may wait until a predetermined threshold number of responses have been received before evaluating the responses against the consensus criteria. Additionally or alternatively, the system may evaluate each response as it is received and determine an action to be executed as soon as the received responses match the consensus criteria. For example, if the consensus criteria requires that six out of ten group members must approve the pending transfer, the system may stop receiving responses after receiving six approvals, or may wait for all ten responses before making a determination. As discussed with regards to FIG. 4, each group member 103 may be associated with a level of authority which may factor into the system's evaluation of the responses. Therefore, for example, if the consensus criteria requires authorization from a majority of group members, and the responses are tied between authorizations and denials, the system may make a determination based on the response of a group member with a tiebreaker level of authority. In another example, the system may determine that the consensus criteria has been met, but only under the conditions specified by a group member with a highest level of authority.

The process may then continue to block 640, wherein the remote consensus system 200 may transmit instructions to the managing entity system 300. The instructions may include an authorization or denial of the pending resource transfer, as well as any additional instructions relating to other conditions set by the group members. For example, the system may transmit instructions to the managing entity system approving the pending resource transfer for a later date or time, approving the pending resource transfer but subsequently placing a hold on the user account, and/or the like. In some embodiments, the system 200 may also transmit a notification to the user device 104 of the user 102 and/or the user device(s) 104 of the group member(s) 103 summarizing the results of the authorization requests as well as indicating the determined action. The summarized results may vary depending on the permissions of each group member 103, such that an identity of the group member that sent in each result may be visible to all group members, only group members with certain predetermined permissions, only the user 102, neither the user 102 or any other group member 103, or any combination of the foregoing.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for remote consensus authorization, the system comprising:
at least one non-transitory storage device; and
at least one processing device coupled to the at least one non-transitory storage device, wherein the at least one processing device is configured to:
receive, from a managing entity system, information associated with a pending resource transfer, wherein the information comprises information identifying a user associated with the pending resource transfer;
receive, from a user device associated with the user, information identifying a plurality of group members and a level of permission for each of the plurality of group members;
predict, via a machine learning engine, that the pending resource transfer, in combination with a set of decision factors, will meet a set of requirements for a consensus trigger;
transmit, to a plurality of one or more user devices, wherein each of the plurality of user devices is associated with a group member, a request for authorization of the pending resource transfer;
receive, from each of the plurality of user devices, [[a]] at least one response, wherein each response comprises either an authorization or a denial of the pending resource transfer and wherein a number of responses received from each user device is based on the level of permission of an associated group member;
determine, based on the responses, that an amount of responses comprising an authorization meets a predetermined threshold amount of authorization responses; and
transmit, to the managing entity system, instructions to authorize the pending resource transfer.

2. (canceled)

3. The system of claim 1, wherein information associated with a pending resource transfer further comprises at least one of: a transfer amount, information identifying a user account or resource instrument associated with the pending resource transfer, a present balance associated with the user account or resource instrument, a merchant or third party system associated with the pending resource transfer, or a spending category.

4. The system of claim 1, wherein the set of decision factors comprises at least one of: historical user data, past account activity, frequency of past resource transfers, amounts of past resource transfer, spending categories of past resource transfers, or results of past remote consensus requests.

5. The system of claim 1, wherein each response further comprises one or more conditions for authorization and wherein determining, based on the responses, that an amount of responses comprising an authorization meets a predetermined threshold amount of authorization responses further comprises determining a majority of the responses comprise one or more matching conditions for authorization.

6. The system of claim 5, wherein the instructions to authorize the pending resource transfer further comprise instructions to only authorize the pending resource transfer when the one or more matching conditions are met.

7. The system of claim 1, wherein the at least one processing device is further configured to predict, via the machine learning engine, that the pending resource transfer, in combination with the set of decision factors, will meet a set of requirements for an automatic transfer authorization or an automatic transfer denial.

8. The system of claim 7, wherein the set of requirements for a consensus trigger and the set of requirements for automatic transfer authorization or automatic transfer denial are determined based on input received from a user device associated with the user.

9. A computer program product for remote consensus authorization, the computer program product comprising at least one non-transitory computer-readable medium having computer-readable program code portions embodied therein, the computer-readable program code portions comprising:
an executable portion configured to receive, from a managing entity system, information associated with a pending resource transfer, wherein the information comprises information identifying a user associated with the pending resource transfer;
an executable portion configured to receive, from a user device associated with the user, information identifying a plurality of group members and a level of permission for each of the plurality of group members;
an executable portion configured to predict, via a machine learning engine, that the pending resource transfer, in combination with a set of decision factors, will meet a set of requirements for a consensus trigger;
an executable portion configured to transmit, to a plurality of one or more user devices, wherein each of the plurality of user devices is associated with a group member, a request for authorization of the pending resource transfer;
an executable portion configured to receive, from each of the plurality of user devices, at least one response, wherein each response comprises either an authorization or a denial of the pending resource transfer and wherein a number of responses received from each user device is based on the level of permission of an associated group member;
an executable portion configured to determine, based on the responses, that an amount of responses comprising an authorization meets a predetermined threshold amount of authorization responses; and
an executable portion configured to transmit, to the managing entity system, instructions to authorize the pending resource transfer.

10. (canceled)

11. The computer program product of claim 9, wherein information associated with a pending resource transfer further comprises at least one of: a transfer amount, information identifying a user account or resource instrument associated with the pending resource transfer, a present balance associated with the user account or resource instrument, a merchant or third party system associated with the pending resource transfer, or a spending category.

12. The computer program product of claim 9, wherein the set of decision factors comprises at least one of: historical user data, past account activity, frequency of past resource transfers, amounts of past resource transfer, spending categories of past resource transfers, or results of past remote consensus requests.

13. The computer program product of claim 1, wherein each response further comprises one or more conditions for authorization and wherein determining, based on the responses, that an amount of responses comprising an authorization meets a predetermined threshold amount of authorization responses further comprises determining a majority of the responses comprise one or more matching conditions for authorization.

14. The computer program product of claim 13, wherein the instructions to authorize the pending resource transfer further comprise instructions to only authorize the pending resource transfer when the one or more matching conditions are met.

15. The computer program product of claim 9, further comprising an executable portion configured to predict, via the machine learning engine, that the pending resource transfer, in combination with the set of decision factors, will meet a set of requirements for an automatic transfer authorization or an automatic transfer denial.

16. The computer program product of claim 15, wherein the set of requirements for a consensus trigger and the set of requirements for automatic transfer authorization or automatic transfer denial are determined based on input received from a user device associated with the user.

17. A computer-implemented method for remote consensus authorization, the method comprising:
receiving, from a managing entity system, information associated with a pending resource transfer, wherein the information comprises information identifying a user associated with the pending resource transfer;
receiving, from a user device associated with the user, information identifying a plurality of group members and a level of permission for each of the plurality of group members;
predicting, via a machine learning engine, that the pending resource transfer, in combination with a set of decision factors, will meet a set of requirements for a consensus trigger;
transmitting, to a plurality of one or more user devices, wherein each of the plurality of user devices is associated with a group member, a request for authorization of the pending resource transfer;
receiving, from each of the plurality of user devices, [[a]] at least one response, wherein each response comprises either an authorization or a denial of the pending resource transfer and wherein a number of responses received from each user device is based on the level of permission of an associated group member;
determining, based on the responses, that an amount of responses comprising an authorization meets a predetermined threshold amount of authorization responses; and
transmitting, to the managing entity system, instructions to authorize the pending resource transfer.

18. The system of claim 1, wherein information associated with a pending resource transfer further comprises at least one of: a transfer amount, information identifying a user account or resource instrument associated with the pending resource transfer, a present balance associated with the user account or resource instrument, a merchant or third party system associated with the pending resource transfer, or a spending category and wherein the set of decision factors comprises at least one of: historical user data, past account activity, frequency of past resource transfers, amounts of past resource transfer, spending categories of past resource transfers, or results of past remote consensus requests.

19. The system of claim 1, wherein each response further comprises one or more conditions for authorization, wherein determining, based on the responses, that an amount of responses comprising an authorization meets a predetermined threshold amount of authorization responses further comprises determining a majority of the responses comprise one or more matching conditions for authorization, and wherein the instructions to authorize the pending resource transfer further comprise instructions to only authorize the pending resource transfer when the one or more matching conditions are met.

20. The system of claim 1, wherein the at least one processing device is further configured to predict, via the machine learning engine, that the pending resource transfer, in combination with the set of decision factors, will meet a set of requirements for an automatic transfer authorization or an automatic transfer denial, wherein the set of requirements for a consensus trigger and the set of requirements for automatic transfer authorization or automatic transfer denial are determined based on input received from a user device associated with the user.
